(19) United States
(12) Patent Application Publication
(10) Pub. No.: US 2006/0230952 A1
(43) Pub. Date: Oct. 19, 2006

(54) System and method for pad printing

(75) Inventors: Il-Jin Kim, Suwon-si (KR); Shin-Chul Kang, Seoul (KR); Hoon-Soo Park, Gwangmyeong-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/392,521

(22) Filed: Mar. 29, 2006

(30) Foreign Application Priority Data
Apr. 14, 2005 (KR) 2005-30927

(51) Int. Cl. B41F 17/00

(52) U.S. Cl. 101/41

(57) ABSTRACT

A pad printing system includes at least one ink color for realizing an image on the surface of a material; at least one copper plate corresponding to the at least one ink color; and a silicon pad for printing the at least one ink color, after being applied to the corresponding copper plate, on the material based on the image to be realized.

### PRIORITY

This application claims priority to an application entitled “System and Method for Pad Printing” filed with the Korean Intellectual Property Office on Apr. 14, 2005 and assigned Serial No. 2005-30927, the contents of which are incorporated herein by reference.

### BACKGROUND OF THE INVENTION

1. Field of the Invention

The present invention relates to a system and a method for pad printing, and more particularly to a system and a method for pad printing using a number of copper plates, which have various colors applied thereto, for printing on the surface of materials.

2. Description of the Related Art

In general, an increasing amount of plastic molding materials are used in various fields including caps of cosmetics, cases of portable telephones, automobiles, and electronic appliances.

The above-mentioned products have poorer endurance and hardness than glass or metal. This may degrade the value of the products. Therefore, various painting methods have been developed to protect the surface of these plastic molding products and improve the hardness and gloss. The most widely used painting methods include a natural drying method, a low-temperature exposure method, and a UV-curing method.

As such, different types of paint are used depending on the properties of the plastic materials, including glass transition temperature and solubility into organic solutions. The limitation on the type of primers and topcoats suitable for each plastic material is a hindrance to improving the productivity and workability during painting.

When a type of paint is used for a plastic material, the paint composition is applied to various plastic materials to form a primer and UV-curable paint or urethane-curable paint is applied thereto to form a topcoat.

Color paint is usually used as the paint composition.

Alternative printing methods for plastic materials include a pad printing method using pads.

In the pad printing method, ink color is applied to carved printing patterns of a metal plate, which are then transferred to a silicon pad and printed on the surface of a plastic material.

### SUMMARY OF THE INVENTION

The prior art has a problem in that, when a topcoat and a primer are formed in a spray painting process using a paint composition for a plastic material, paint having just one color is used in a single process of spray painting. This makes it difficult to realize images of various colors. Even when different spray devices for different colors are used to realize various colors, the colors cannot be mixed, because different colors are successively sprayed on one another.

Conventional pad printing methods have a problem in that it is difficult to mix the colors of a product and realize images of various colors, because only a single kind of color is applied to the surface of the plastic product from a corresponding metal plate.

Accordingly, the present invention has been made to solve at least the above-mentioned problems occurring in the prior art, and an object of the present invention is to provide a system and a method for pad printing using a number of copper plates, which have various colors applied thereto, for successive printing so that mixed colors and images of various colors can be realized on the surface of a material, such as a portable telephone.

Another object of the present invention is to provide a system and a method for pad printing using a number of copper plates, to which various colors of paint is transferred for printing, to obtain an image effect similar to that of blue jeans on the surface of a material, such as a portable telephone.

In order to accomplish these objects, there is provided a pad printing system including at least one ink color for realizing an image on the surface of a material; at least one copper plate corresponding to the at least one ink color; and a silicon pad for printing the at least one ink color, after being applied to the corresponding copper plate, on the material based on the image to be realized.

In accordance with another aspect of the present invention, there is provided a pad printing method including the steps of providing at least one ink color to realize an image on the surface of a material; fabricating a copper plate corresponding to the at least one ink color; applying the at least one ink color to the corresponding copper plate; and printing the at least one ink color, which has been applied to the corresponding copper plate, on the material using a silicon pad to realize the image.

### BRIEF DESCRIPTION OF THE DRAWINGS

The above and other objects, features, and advantages of the present invention will be more apparent from the following detailed description taken in conjunction with the accompanying drawings, in which:

FIG. 1 shows the operation of a pad printing system according to an embodiment of the present invention;

FIG. 2 is a flowchart of a pad printing method according to an embodiment of the present invention; and

FIG. 3 shows an example of application of a pad printing system to a material, particularly, to a portable telephone case, according to an embodiment of the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein is omitted to avoid making the subject matter of the present invention unclear.

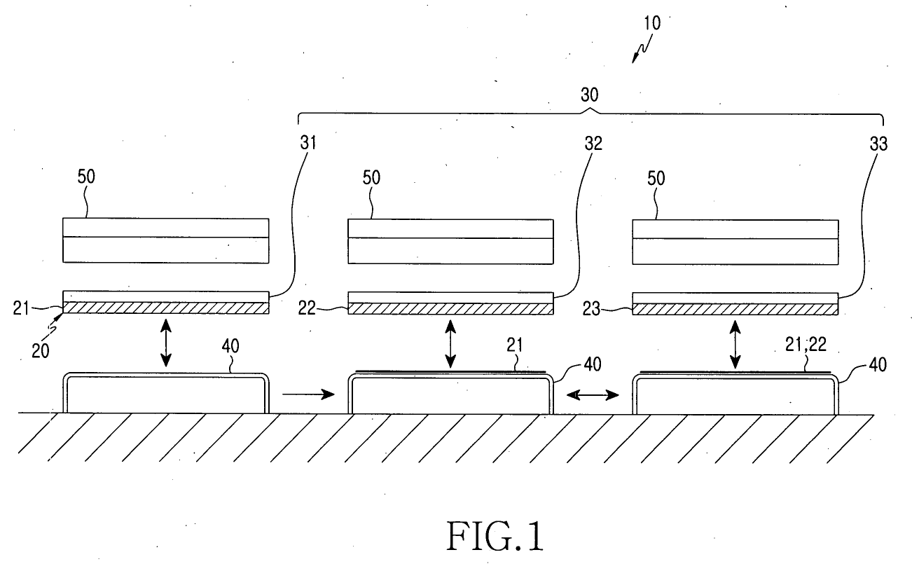

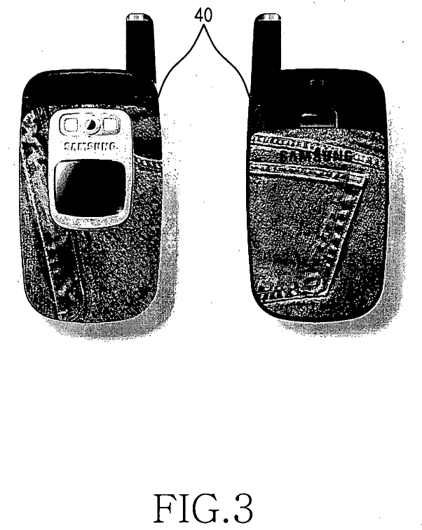

As shown in FIGS. 1 and 3, a pad printing system 10 according to a first preferred embodiment of the present invention includes at least one ink color 20, at least one copper plate 30, and a silicon pad 50.

Various ink colors 20 may be provided to realize an image effect similar to that of blue jeans.

Copper plates 31, 32, and 33 have printing patterns carved thereon to realize the image of blue jeans and corresponds to the various ink colors 20.

The ink colors 20 are applied to the respective copper plates 31, 32, and 33 and are successively printed on the surface of a portable telephone case 40 using the silicon pad 50 to realize the image of blue jeans.

In particular, ink colors including white 21, blue 22, and black 23 are provided to obtain an image effect similar to that of blue jeans on the surface of the portable telephone case 40.

The order of application of the ink colors 20 is white, blue and then black.

The surface of the portable telephone case 40 is subjected to spray coating to protect the image effect of blue jeans and finished with a soft feel.

In the spray coating, UV-curable paint and urethane paint are used.

The operation of the pad printing system according to the first preferred embodiment of the present invention, constructed as above, will now be described in more detail with reference to FIGS. 1 and 3.

As shown in FIG. 1, at least one ink color 20 is provided to realize the image of blue jeans on the surface of a portable telephone case 40.

The ink color 20 includes white 21, blue 22, and black 23.

First, second, and third copper plates 31, 32, and 33 are provided according to the ink colors 21, 22, and 23.

A design (not shown) of carved patterns is formed on the first, second, and third copper plates 31, 32, and 33 to realize the image of blue jeans.

The white ink color 21 is applied to the first copper plate 31 and is printed on the surface of the portable telephone case 40 using a silicon pad 50.

The blue ink color 22 is applied to the second copper plate 32 and is printed on the surface of the portable telephone case 40, to which the white ink color 21 has been applied, using another silicon pad 50.

The black ink color 23 is applied to the third copper plate 33 and is printed on the surface of the portable telephone case 40, to which the white and blue ink colors 21 and 22 have been applied, using another silicon pad 50.

As shown in FIG. 3, the ink colors 20 including white, blue, and black 21, 22, and 23 are applied to the first, second, and third copper plates 31, 32, and 33, while transferring the silicon pads 50 thereto, and are successively printed on the surface of the portable telephone case 40.

The planar surface of the first, second, and third copper plates 31, 32, and 33 is indented a predetermined depth to form a design (not shown) for realizing the image of blue jeans and provide a dented plate. The ink colors 20 are applied to the whole surface. A blade plate (not shown) is used to rub the surface of the first, second, and third copper plates 31, 32, and 33 to leave the ink colors 20 in the indented portions only. The silicon pads 50 are pressed against the surface of the first, second, and third copper plates 31, 32, and 33 so that the ink colors 20, which have remained in the shape of the design for realizing the image of blue jeans, are pressed against the surface of the portable telephone case 40 and printed thereon according to the design.

The surface of the portable telephone case 40 is subjected to spray coating to protect the image effect of blue jeans.

In the spray coating, UV-curable paint and urethane paint are used.

The surface of the portable telephone case 40 is finished with a soft feel by the spray coating.

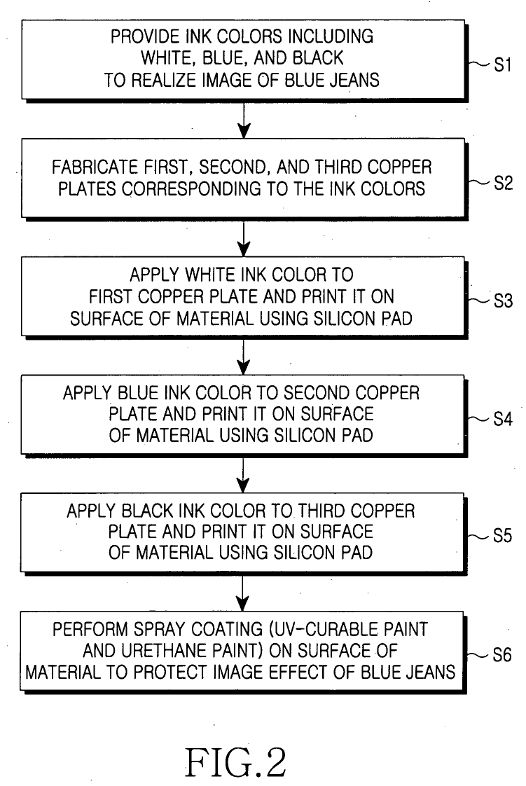

The processes of a pad printing method according to a second preferred embodiment of the present invention will now be described with reference to FIG. 2.

As shown in FIG. 2, at least one ink color 20 (white 21, blue 22, and black 23) is provided to realize the image of blue jeans on a portable telephone case 40 (S1).

First, second, and third copper plates 31, 32, and 33 are fabricated according to the ink colors 21, 22, and 23 provided in the previous step (S2).

A design (not shown) of carved patterns is formed on the first, second, and third copper plates 31, 32, and 33 to realize the image of blue jeans.

The white ink color 21 is applied to the first copper plate 31 and is printed on the surface of the portable telephone case 40 using a silicon pad 50 (S3).

The blue ink color 22 is applied to the second copper plate 32 and is printed on the surface of the portable telephone case 40, to which the white ink color 21 has been applied, using another silicon pad 50 (S4).

The black ink color 23 is applied to the third copper plate 33 and is printed on the surface of the portable telephone case 40, to which the white and blue ink colors 21 and 22 have been applied, using another silicon pad 50 (S5).

The ink colors 20 including the white, blue, and black 21, 22, and 23 are applied to the first, second, and third copper plates 31, 32, and 33, while transferring the silicon pads 50 thereto, and are successively printed on the portable telephone case 40.

The surface of the portable telephone case 40 is subjected to spray coating to protect the image effect of blue jeans (S6).

In the spray coating, UV-curable paint and urethane paint are used.

The surface of the portable telephone case 40 is finished with a soft feel by the spray coating.

As mentioned above, the system and method for pad printing according to the present invention are advantageous in that a number of copper plates are used for successive printing, which have various colors applied thereto, so that mixed colors and images of various colors can be realized on the surface of materials.

The present invention is applicable to all types of portable terminals.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A pad printing system comprising:
at least one ink color for realizing an image on the surface of a material;
at least one copper plate corresponding to the at least one ink color; and
a silicon pad for printing the at least one ink color, after being applied to the corresponding copper plate, on the material based on the image to be realized.

2. The pad printing system as claimed in claim 1, wherein if more than one ink color is used, the colors are applied successively.

3. The pad printing system as claimed in claim 1, wherein the at least one ink color comprises white, blue, and black to obtain an image effect similar to that of blue jeans on the material.

4. The pad printing system as claimed in claim 1, wherein the at least one ink color is applied in an order of white, blue, and black.

5. The pad printing system as claimed in claim 1, wherein the surface of the material is finished by spray coating to protect the image.

6. The pad printing system as claimed in claim 5, wherein UV-curable paint and urethane paint are used in the spray coating.

7. A pad printing method comprising the steps of:
providing at least one ink color to realize an image on the surface of a material;
fabricating a copper plate corresponding to the at least one ink color;
applying the at least one ink color to the corresponding copper plate; and
printing the at least one ink color, which has been applied to the corresponding copper plate, on the material using a silicon pad to realize the image.

8. The pad printing method as claimed in claim 7, wherein if more than one ink color is used, the colors are applied successively.

9. The pad printing method as claimed in claim 7, wherein, in the step of providing at least one ink color, white, blue, and black ink colors are provided to obtain an image effect similar to that of blue jeans on the material.

10. The pad printing method as claimed in claim 7, wherein the ink color is applied in an order of white, blue, and black.

11. The pad printing method as claimed in claim 7, wherein, after the ink color is applied to the material, the surface of the material is subjected to spray coating to protect the image.

12. The pad printing method as claimed in claim 11, wherein UV-curable paint and urethane paint are used in the spray coating.
